(19) United States
(12) Patent Application Publication
(10) Pub. No.: US 2024/0255608 A1
(43) Pub. Date: Aug. 1, 2024

(54) SIGNAL STRUCTURE DESIGNS FOR WIRELESS COMMUNICATION AND SENSING

(71) Applicant: ZTE Corporation, Shenzhen (CN)

(72) Inventors: Yihua MA, Shenzhen (CN); Zhifeng YUAN, Shenzhen (CN); Guanghui YU, Shenzhen (CN); Shuqiang XIA, Shenzhen (CN); Liujun HU, Shenzhen (CN)

(21) Appl. No.: 18/633,059

(22) Filed: Apr. 11, 2024

Related U.S. Application Data
(63) Continuation of application No. PCT/CN2021/132956, filed on Nov. 25, 2021.

(51) Int. Cl. G01S 7/00; G01S 7/282; G01S 7/35; G01S 13/86; H04L 5/00

(52) U.S. Cl. CPC G01S 7/006; G01S 7/282; G01S 7/35; G01S 13/86; H04L 5/0007

(57) ABSTRACT

Techniques are described for transmission and/or reception of signal structure designs for joint communications and sensing. An example wireless communication method includes transmitting, by a wireless device, a waveform that includes a signal structure having one or more time resources or one or more frequency resources, where the signal structure includes a plurality of data signals, where the signal structure includes a plurality of sensing signals configured to reflect from an object in an area where the wireless device is operating, and where locations of the plurality of sensing signals in the signal structure form an irregular pattern.

### CROSS REFERENCE TO RELATED APPLICATIONS TECHNICAL FIELD

This patent document is a continuation of and claims benefit of priority to International Patent Application No. PCT/CN2021/132956, filed on Nov. 25, 2021. The entire content of the before-mentioned patent application is incorporated by reference as part of the disclosure of this application.

### TECHNICAL FIELD

This disclosure is directed generally to digital wireless communications.

### BACKGROUND

Mobile telecommunication technologies are moving the world toward an increasingly connected and networked society. The rapid growth of wireless communications and advances in technology has led to greater demand for capacity and connectivity. Other aspects, such as energy consumption, device cost, spectral efficiency, and latency can also be important to meeting the needs of various communication scenarios. In comparison with the existing wireless networks, next generation systems and wireless communication techniques will need to support a much wider range of use-case characteristics and provide a more complex and sophisticated range of access requirements and flexibilities.

### SUMMARY

Techniques are disclosed for signal structure designs for joint communications and sensing for wireless technologies.

A first wireless communication method includes transmitting, by a wireless device, a waveform that includes a signal structure having one or more time resources or one or more frequency resources, where the signal structure includes a plurality of data signals, where the signal structure includes a plurality of sensing signals configured to reflect from an object in an area where the wireless device is operating, and where locations of the plurality of sensing signals in the signal structure form an irregular pattern.

A second wireless communication method includes receiving, by a wireless device, a reflected waveform that is reflected from an object in an area where the wireless device is operating, where the reflected waveform comprises at least some of a plurality of sensing signals in a signal structure transmitted by the wireless device or by another wireless device, and where locations of the plurality of sensing signals in the signal structure form an irregular pattern.

A third wireless communication method includes transmitting, by a wireless device, a waveform that includes a signal structure, where the signal structure includes a plurality of data signals, where the signal structure includes a plurality of sensing signals configured to reflect from an object in an area where the wireless device is operating resulting in a reflected waveform that comprises at least some of the plurality of sensing signals to be received by the wireless device, and where locations of the plurality of sensing signals in the signal structure form an irregular pattern; receiving, by the wireless device, the reflected waveform; and determining, by processing the reflected waveform, at least one parameter of the object.

In some embodiments, the one or more parameters of the object include a distance between the object and the wireless device, a speed of the object, a motion period of the object, or an image of the object. In some embodiments, the signal structure comprises a plurality of time slots, and the irregular pattern is formed by at least one sensing signal that is randomly located in at least one symbol within each time slot from the plurality of time slots. In some embodiments, the signal structure comprises a plurality of time slots, and the irregular pattern is formed by at least one sensing signal that is randomly located within each time slot from the plurality of time slots. In some embodiments, the signal structure comprise a plurality of sub-frames, the irregular pattern is formed by at least one spreading code being randomly selected for at least one sensing signal within each sub-frame of the plurality of sub-frames, each sub-frame includes one or more spreading codes corresponding to one or more data signals, and the at least one spreading code for the at least one sensing signal is different than the one or more spreading codes for the one or more data signals.

In some embodiments, the at least one spreading code includes an orthogonal spreading code in time domain or frequency domain. In some embodiments, the at least one spreading code includes a non-orthogonal spreading code in time domain or frequency domain. In some embodiments, the signal structure comprises a plurality of symbols and a plurality of resource blocks, a set of sensing signals are periodically repeated within the plurality of symbols within each sub-carrier in a subset of sub-carriers from a plurality of sub-carriers, and the irregular pattern is formed by the set of sensing signals that are located in each sub-carrier in the subset of sub-carriers from the plurality of sub-carriers. In some embodiments, the signal structure comprises a plurality of time slots and a plurality of resource blocks, the irregular pattern is formed by one or more sensing signals that are located in each resource block from the plurality of resource blocks, and the irregular pattern is formed by at least one sensing signal that is located in each time slot from the plurality of time slots.

In some embodiments, the signal structure comprises a plurality of symbols and a plurality of resource blocks, a set of sensing signals are periodically repeated within the plurality of symbols within each sub-carrier in a subset of sub-carriers from a plurality of sub-carriers, the irregular pattern is formed by the set of sensing signals that are located in each sub-carrier in the subset of sub-carriers from the plurality of sub-carriers, and a number of sub-carriers in between one sub-carrier that includes the set of sensing signals and another sub-carrier that includes the set of sensing signal increases as a sub-carrier index of the plurality of sub-carriers increases. In some embodiments, the plurality of sensing signals include a frequency modulation continuous wave (FMCW) signal, a pulse signal, or a low-correlation sequence. In some embodiments, the low-correlation sequence includes an m-sequence, a pseudo-noise sequence, a gold sequence, or a Zadoff-Chu sequence. In some embodiments, the plurality of sensing signals are included in a first set of multiple time resources and/or a first set of one or more frequency resources. In some embodiments, the plurality of data signals are included in a second set of one or more time resources and/or a second set of one or more frequency resources. In some embodiments, the wireless device includes a network device or a communication device.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 shows a Doppler sensing performance comparison of sensing-only, time-division and random time-division (RID) schemes.

FIG. 2 shows multiple time slots where the communications and sensing signals are located at different symbols.

FIG. 3 shows multiple sub-frames where the communications and sensing signals are located at different time slots.

FIG. 4 shows that communications and sensing signals are separated by different spreading codes in the symbol.

FIG. 5 shows an example of a time-domain chirp signal focusing its energy in the l-th occasion, where l=3.

FIG. 6 shows that the communications and sensing signals are located at different sub-carriers and symbols.

FIG. 7 shows that the communications and sensing signals are located at different resource blocks and slots.

FIG. 8 shows that the communications and sensing signals are located at different sub-carriers and symbols.

FIG. 9 shows an exemplary block diagram of a hardware platform that may be a part of a network device or a communication device.

FIG. 10 shows an example of wireless communication including a base station (BS) and user equipment (UE) based on some implementations of the disclosed technology.

FIG. 11 shows an exemplary flowchart for transmitting a waveform comprising joint communications and sensing signals.

FIG. 12 shows an exemplary flowchart for receiving a reflected waveform comprising one or more sensing signals.

FIG. 13 shows an exemplary flowchart for processing one or more sensing signals in a reflected waveform.

### DETAILED DESCRIPTION

Joint communications and sensing is a promising 6G technology but a technical challenge is how to effectively and/or efficiently integrate them. Frequency-division and time-division coexistence can hardly bring a gain of integration. Directly using orthogonal frequency-division multiplexing (OFDM) to sense requires complex in-band full-duplex (FD) to cancel the self-interference (SI). To solve at least these technical problems, this patent document proposes example signal structure that can increase spectrum efficiency in some embodiments.

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G or 6G terminology is used for the sake of clarity of explanation, but the techniques disclosed in the present document are not limited to 5G or 6G technology only, and may be used in wireless systems that implemented other protocols.

### I. Introduction

6G is going to not only evolve in terms of spectral efficiency, latency, and connectivity but may also seek to provide beyond-communications services. Joint communications and sensing (JCS) can provide sensing services through the communications devices. The RF convergence of these two functions (i.e., JCS) also makes it possible to realize an efficient joint scheme to share the resources including spectrum and hardware.

Although the unified design is preferable to save the cost, the two functions themselves have different working principles. Communications aim to get the information from the transmitted signal itself while sensing focuses on the channel information. Communications usually employ orthogonal frequency-division multiplexing (OFDM), as it provides robustness against multi-path channels, simple equalization and flexible resource allocation. In radar sensing, the widely used solution is based on frequency modulated continuous wave (FMCW) or chirp signal for its large bandwidth, simple processing scheme, and importantly, simple self-interference (SI) cancellation.

OFDM can be used to sense. The data transmission efficiency and flexibility can be ensured, and the sensing overheads can be reduced via reusing data symbols to sense. The problem is that a complex in-band full-duplex transceiver is required. As SI is much stronger than the echos, full-duplex usually cancels SI in multiple domains, including spatial domain, RF/analog domain and digital domain. When the multiple-input and multiple-output (MIMO) system is used, all transmit antennas generate SI, which makes the SI cancellation much more complex than the single-antenna situation.

FMCW was also considered to communicate in JCS. The simplest way is to modulate the amplitude, frequency or phase of the chirp signal, which is only for low-rate communications. OFDM chirp methods were designed to generate orthogonal FMCW signals for MIMO radar. Furthermore, Orthogonal chirp division multiplexing replaces the Fourier transform kernel in OFDM with the Fresnel transform and uses a DFT-spread-OFDM (DFT-s-OFDM) receiver. Although FMCW and OFDM are combined, these methods lose the advantages of multi-path robustness of OFDM, as well as the efficient SI suppression of FMCW.

### II. Example JCS Techniques

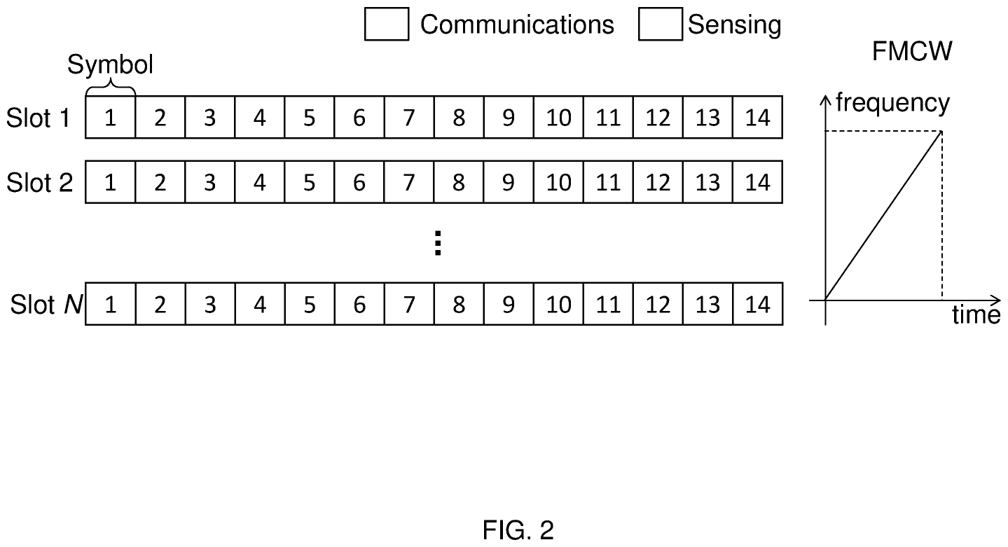

Time-division coexistence is considered. Compared to frequency-division coexistence, time-division can use all the bandwidth for sensing. Assume that the total time is Tₜₒₜ=MKT_{chirp}, where M is the number of chirps/slots in one time group, and K is the number of time groups. The chirp has a length of one time slot. If all resources are used for sensing, the sensed Doppler frequency range is [−½T_{chirp}, ½T_{chirp}). If the first slot in every time slot group is used for sensing, the Doppler range is reduced to 1/M due to the sampling frequency reduction. As shown in FIG. 2, the frequency out of the range is aliased into the lower frequency. That is to say, the Doppler range is reduced with partial time-division resources in the existing method.

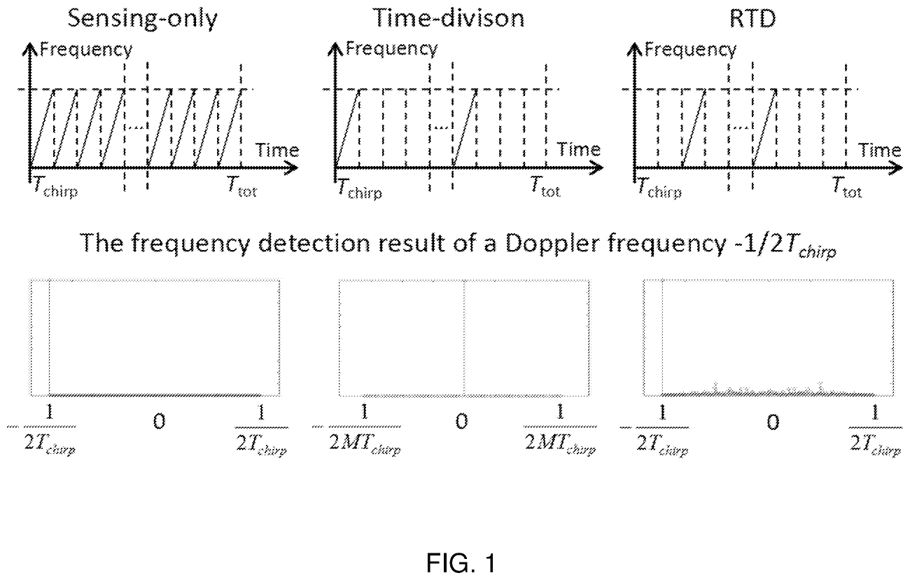

Compared to existing periodic time-division coexistence, random time-division randomly samples the Doppler frequency. In FIG. 1, K slots out of MK slots are randomly selected for sensing, and the sensing resources used are still 1/M of the total resources. The random selection can be realized via a pseudo-noise algorithm or according to a pseudo-noise sequence. Random time-division is still able to recover the Doppler frequency ranging as large as the sensing-only schemes via simple matched filtering. Compared to sensing-only schemes, the remaining (M−1)/M resources can be used for communications. It can be seen from FIG. 1 that the power of target Doppler frequency is much stronger than the cross-frequency interference, which means that random time-division is effective to gain a super Doppler range with only partial resources.

Some examples of signal structure comprising communications signals (e.g., data signals) and sensing signals are described in Embodiments 1 to 7 in this patent document. In several figures corresponding to Embodiments 1 to 7, this patent document shows examples of irregular pattern of the signal structure. The term “irregular pattern” can also be described as non-uniform pattern, aperiodic pattern and pseudo-random pattern.

### II.(a) Embodiment 1—Random Symbol in Each Slot

As shown in FIG. 2, the communications and sensing signals are located at different symbols. In some embodiments, sensing signals can be transmitted by a wireless device (e.g., a network device or a communication device) with the communications (or data) signals in a waveform, and at least some of the sensing signals can be reflected from one or more objects (e.g., another wireless device or building or person, etc.,) so that a reflected waveform comprising the at least some of the sensing signals can be received by the same wireless device or at least one of other wireless devices. The wireless device that receives the one or more sensing signals can use the one or more sensing signals to get the information about the environment. Examples of information about the environment can include spatial information (e.g., location(s) of one or more objects in an area where the wireless device is operating), the speed information of moving targets, the vital signals of a person (e.g., motion period of the object such as one or more times when the object is moving), the imaging information in the radio coverage (e.g., image of the object), etc. The wireless device can calculate the delay of the sensing signal(s) to determine the distance information between the wireless device and an object reflecting the sensing signal, or the wireless device can calculate the Doppler frequency of a sensing signal to determine the speed information of the object reflecting the sensing signal. Each slot has 14 symbols. In each slot, the network device (e.g., base station) or the communication device (e.g., user equipment (UE)) transmitting the sensing signal randomly selects positions or indexes of symbols to transmit in the sensing signal. The random selection can be realized via a pseudo-noise algorithm or according to a pseudo-noise sequence. In this embodiment, the position of sensing signal is at the symbol with an index generated by a uniform distribution of 1˜14 in each slot. The remaining resources other than the resources used for the sensing signal are used for communications. Different types of sensing signals can be used in one symbol. In this embodiment, FMCW signal is assumed to be used in one symbol.

### II.(b) Embodiment 2—Random Slot in Each Sub-Frame

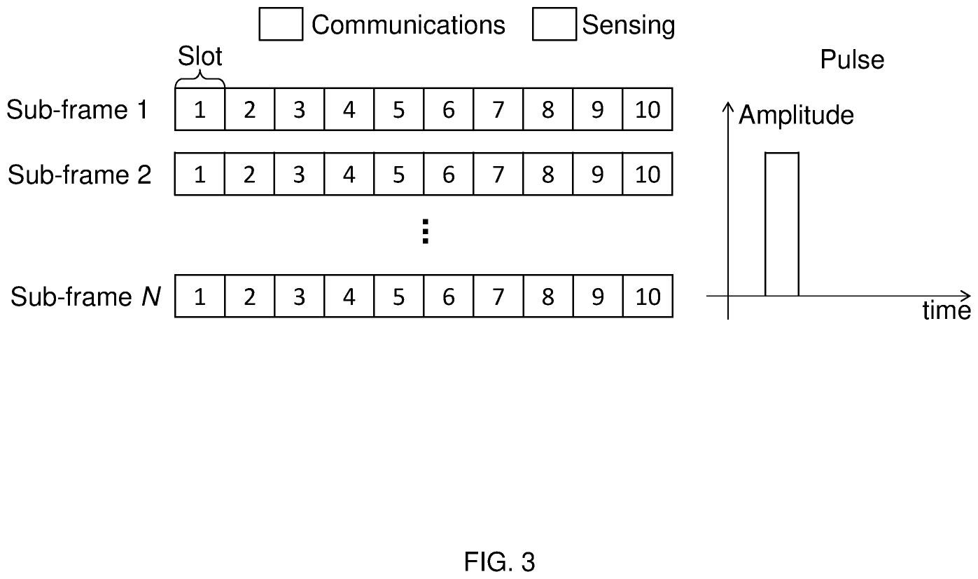

As shown in FIG. 3, the communications and sensing signals are located at different slots. Each sub-frame has 10 slots. In each sub-frame, the network device or the communication device transmitting the sensing signal randomly selects slots to transmit the sensing signal. The random selection can be realized via a pseudo-noise algorithm or according to a pseudo-noise sequence. In this embodiment, each slot has a probability of ¼ to be used by the sensing signal. The remaining resources other than the resources used for the sensing signal are for communications. Different types of sensing signals can be used in one symbol. In this embodiment, pulse signal is assumed to be used in one symbol.

### II.(c) Embodiment 3—Random Code Domain Resource in Symbol

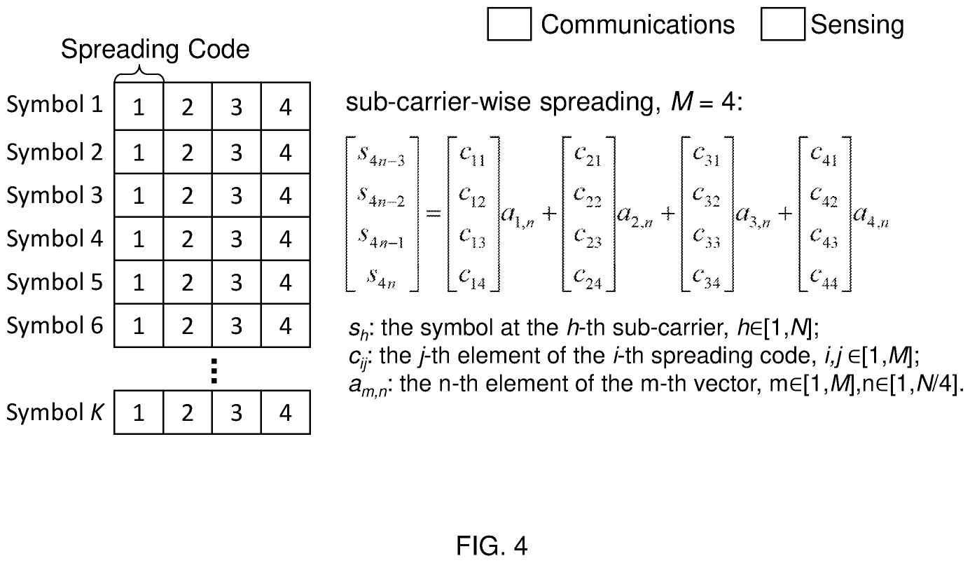

As shown in FIG. 4, the communications and sensing signals are separated by different spreading codes in the symbol. There are M=4 orthogonal codes. In each sub-frame, the network device or the communication device transmitting the sensing signal randomly selects one spreading code (or index of the one spreading code) to transmit the sensing signal. The random selection can be realized via a pseudo-noise algorithm or according to a pseudo-noise sequence. The remaining resources other than the resources used for the sensing signal are used for communications. In this embodiment, the code index for sensing in each symbol is uniformly random in the range from 1 to 4. Different types of sensing signals can be used in one symbol. In this embodiment, m-sequence is assumed to be used as the sensing signal in one symbol. That is to say, if the code index l is selected for sensing, [aₗ₁, aₗ₂, . . . , a_{lN/4}] is a pseudo-noise sequence with a length of N/4.

### II.(d) Embodiment 4—Specific Code Set and the Technical Effect

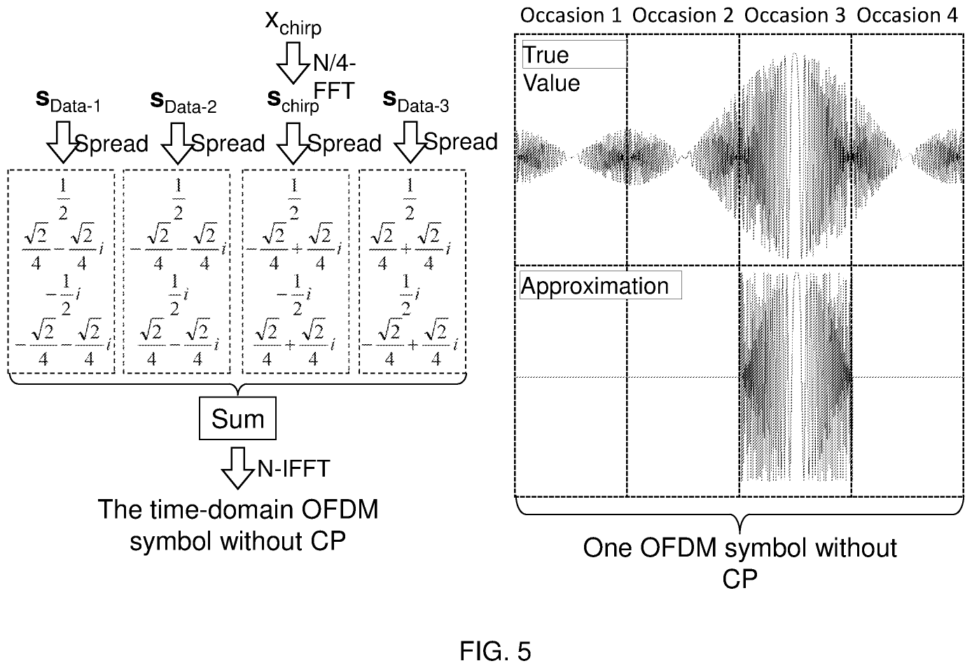

Embodiment 4 is the same as the Embodiment 3 except that the sensing signal is the chirp signal in the time domain instead of the m-sequence in the frequency domain. Chirp signal is a common FMCW signal. As already shown in FIG. 4, the communications and sensing signals are separated by different spreading codes in the symbol. There are M=4 orthogonal codes. In each sub-frame, the network device or the communication device transmitting the sensing signal randomly selects one spreading code (or index of the one spreading code) to transmit the sensing signal. The random selection can be realized via a pseudo-noise algorithm or according to a pseudo-noise sequence. The remaining resources other than the resources used for the sensing signal are used for communications. In this embodiment, the code index for sensing in each symbol is uniformly random in the range from 1 to 4. Different types of sensing signals can be used in one symbol. In this embodiment, the time-domain chirp signal is assumed to be used as the sensing signal in one symbol. For example, if the code index l is selected for sensing, [aₗ₁, aₗ₂, . . . , a_{lN/4}] is a N/4-dimension Fourier transform of a chirp signal with N/4 sampling points. An example of M=4, and l=3 is shown in FIG. 5. With the specific choice of the spread code, the time-domain chirp signal focuses it energy in the l-th occasion, which can be approximated by a time-division chirp signal within an OFDM symbol. This approximation helps to simplify the receiver processing.

### II.(e) Embodiment 5—Random Subcarriers and Periodic Symbols

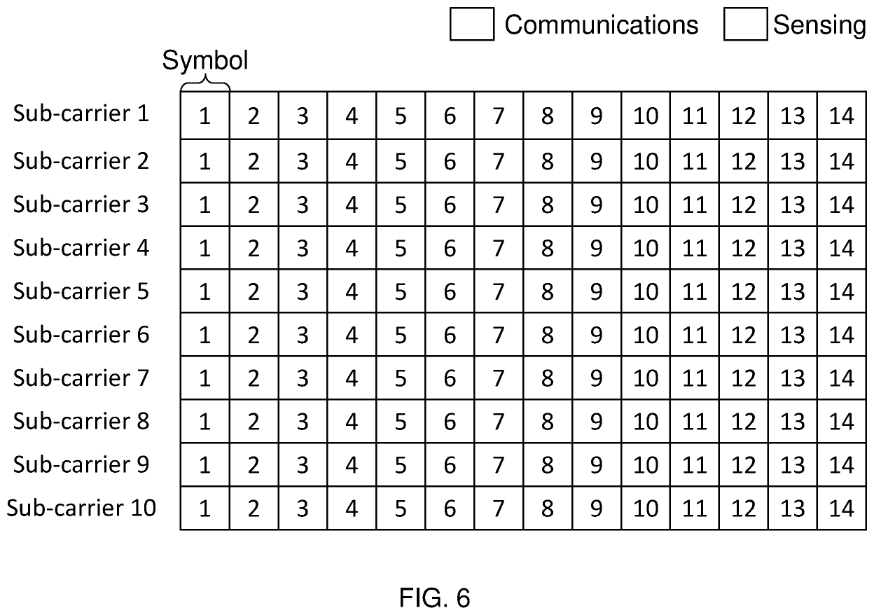

As shown in FIG. 6, the communications and sensing signals are located at different sub-carriers and symbols, or at different resource elements. In this embodiment, the resource elements used by the sensing signal is at both time and frequency domain. In the time domain, the occasions for sensing signal is periodic. In the frequency domain, each sub-carrier has an equal chance of ½ to be used by sensing signal in some embodiments. For example, as shown in FIG. 6, out of the 10 sub-carriers, the network device or the communication device selects 5 sub-carriers to include the sensing signals. As the time-domain pattern is regular, this embodiment can be seen as an example of irregular frequency pattern. The remaining resources other than the resources used for the sensing signal are used for communications. Different types of sensing signals can be used in this scheme. In this embodiment, gold sequence is assumed to be used.

### II.(f) Embodiment 6—Random Subcarriers and Random Slots

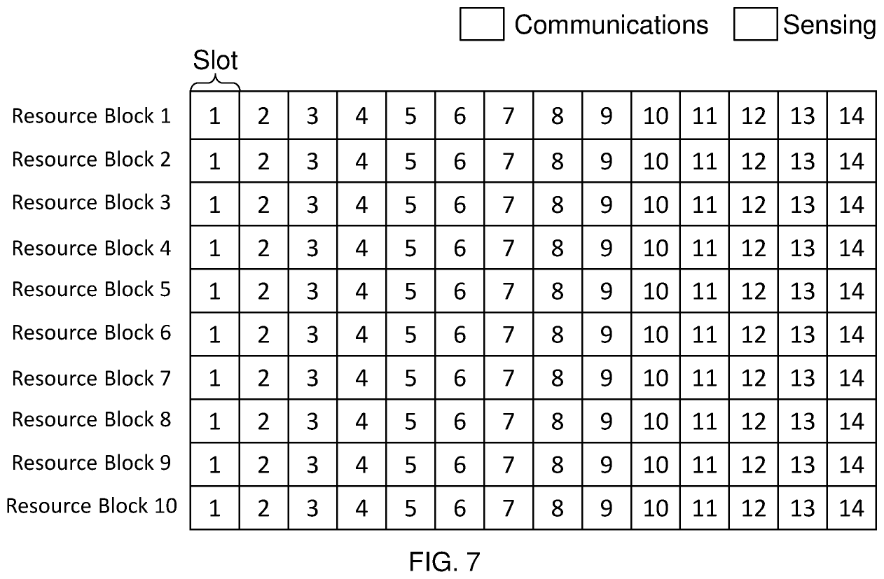

As shown in FIG. 7, the communications and sensing signals are located at different resource blocks and slots. In this embodiment, the position of sensing signal is at both time and frequency domain. From the view of the time domain, each slot can have equal chance (or probability) of 1/7 to be used by sensing signal in some embodiments as shown in FIG. 7. From the view of the frequency domain, each resource block can have an equal chance (or probability) of ⅕ to be used by sensing signal in some embodiments as shown in FIG. 7. This embodiment can be seen as an example of irregular time and frequency pattern. The remaining resources other than the resources used for the sensing signal are used for communications. Different types of sensing signals can be used in this scheme. In this embodiment, gold sequence is assumed to be used.

### II.(g) Embodiment 7—Specific Subcarriers and Periodic Symbols

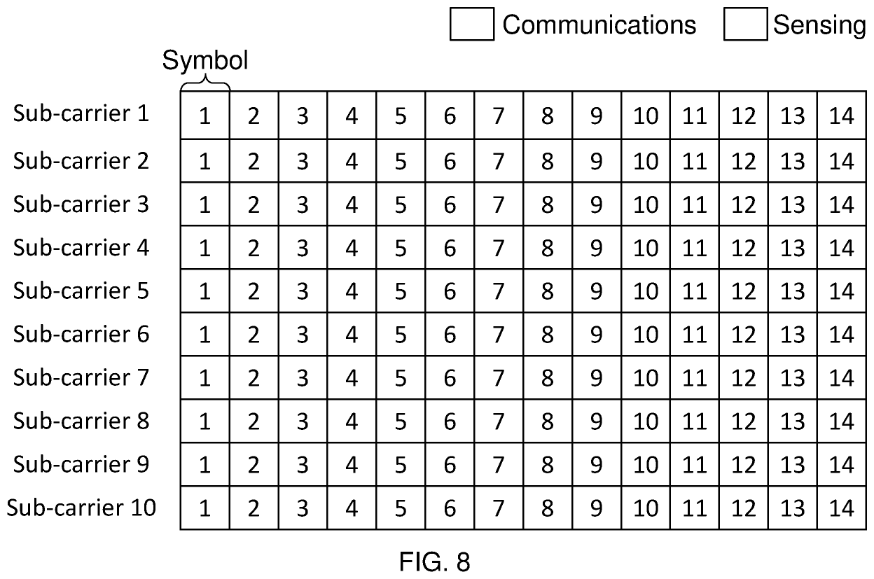

As shown in FIG. 8, the communications and sensing signals are located at different sub-carriers and symbols, or at different resource elements. In this embodiment, the resource elements used by the sensing signal is at both time and frequency domain. In the time domain, the occasions for sensing signal is periodic. In the frequency domain, the sub-carriers for sensing signal has an increasing gap. As the time-domain pattern is regular, this embodiment can be seen as an example of irregular frequency pattern. The remaining resources other than the resources used for the sensing signal are used for communications. Different types of sensing signals can be used in this scheme. In this embodiment, gold sequence is assumed to be used.

The following section describes example techniques and/or design structures described in this patent document:
A signal structure contains both communications signal and sensing signal, and the sensing signal has irregular resource pattern.
The irregular resource pattern is in the at least one of the time domain, frequency domain, and code domain.
The irregular resource pattern can be generated using randomization or specific structure.
The mentioned time domain can be at symbol-wise, slot-wise or frame-wise.
The mentioned frequency domain can be at sub-carrier-wise, or resource-block-wise.
The mentioned code domain can be orthogonal or non-orthogonal code spreading at least one of the time and frequency domain.
The sensing signal can be FMCW, pulse and low-correlation sequences.
The low-correlation sequences include m-sequence, pseudo-noise sequence, gold sequence, and Zadoff-Chu sequence.
A transmitter which transmits a signal with such structure.
A receiver which receives a signal with such structure.

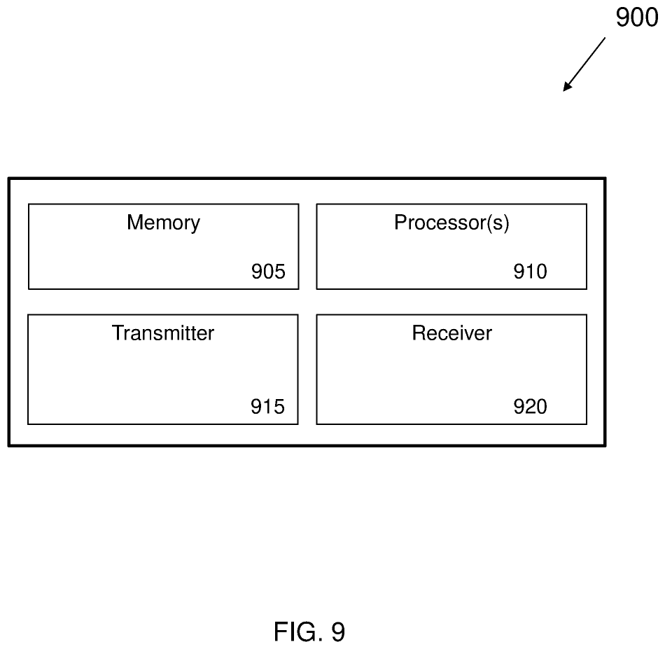

FIG. 9 shows an exemplary block diagram of a hardware platform 900 that may be a part of a network device (e.g., base station) or a communication device (e.g., a user equipment (UE)). The hardware platform 900 includes at least one processor 910 and a memory 905 having instructions stored thereupon. The instructions upon execution by the processor 910 configure the hardware platform 900 to perform the operations described in FIGS. 1 to 8 and 10 to 13 and in the various embodiments described in this patent document. The transmitter 915 transmits or sends information or data to another device. For example, a network device transmitter can send a message to a user equipment. The receiver 920 receives information or data transmitted or sent by another device. For example, a user equipment can receive a message from a network device.

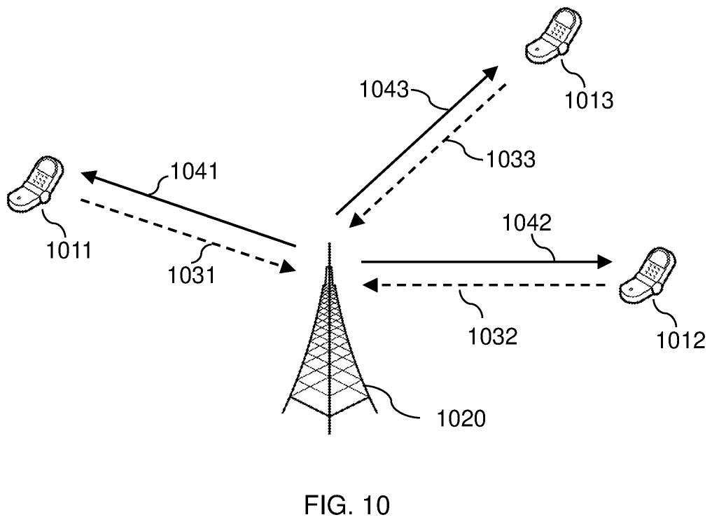

The implementations as discussed above will apply to a wireless communication. FIG. 10 shows an example of a wireless communication system (e.g., a 5G or 6G or NR cellular network) that includes a base station 1020 and one or more user equipment (UE) 1011, 1012 and 1013. In some embodiments, the UEs access the BS (e.g., the network) using a communication link to the network (sometimes called uplink direction, as depicted by dashed arrows 1031, 1032, 1033), which then enables subsequent communication (e.g., shown in the direction from the network to the UEs, sometimes called downlink direction, shown by arrows 1041, 1042, 1043) from the BS to the UEs. In some embodiments, the BS send information to the UEs (sometimes called downlink direction, as depicted by arrows 1041, 1042, 1043), which then enables subsequent communication (e.g., shown in the direction from the UEs to the BS, sometimes called uplink direction, shown by dashed arrows 1031, 1032, 1033) from the UEs to the BS. The UE may be, for example, a smartphone, a tablet, a mobile computer, a machine to machine (M2M) device, an Internet of Things (IOT) device, and so on.

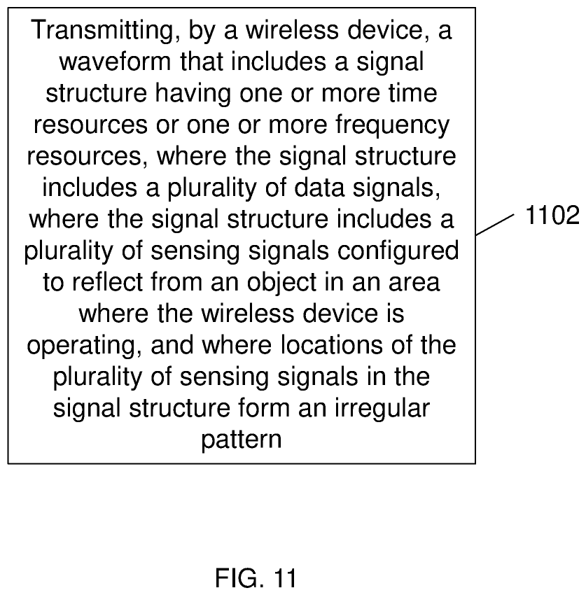

FIG. 11 shows an exemplary flowchart for transmitting a waveform comprising joint communications and sensing signals. Operation 1102 includes transmitting, by a wireless device, a waveform that includes a signal structure having one or more time resources or one or more frequency resources, where the signal structure includes a plurality of data signals, where the signal structure includes a plurality of sensing signals configured to reflect from an object in an area where the wireless device is operating, and where locations of the plurality of sensing signals in the signal structure form an irregular pattern.

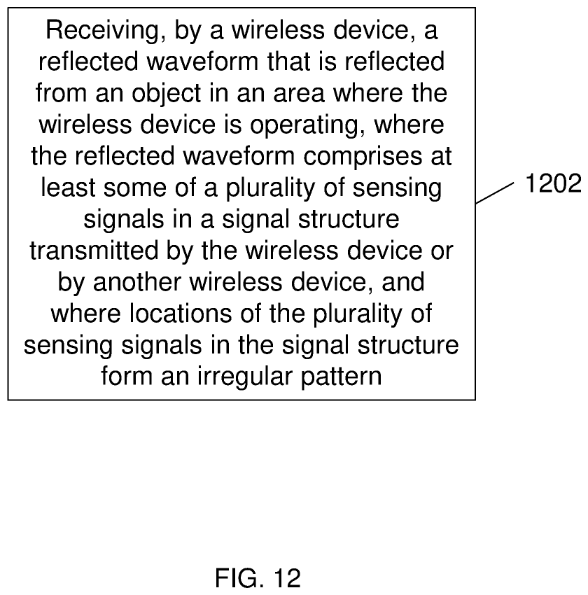

FIG. 12 shows an exemplary flowchart for receiving a reflected waveform comprising one or more sensing signals. Operation 1202 includes receiving, by a wireless device, a reflected waveform that is reflected from an object in an area where the wireless device is operating, where the reflected waveform comprises at least some of a plurality of sensing signals in a signal structure transmitted by the wireless device or by another wireless device, and where locations of the plurality of sensing signals in the signal structure form an irregular pattern.

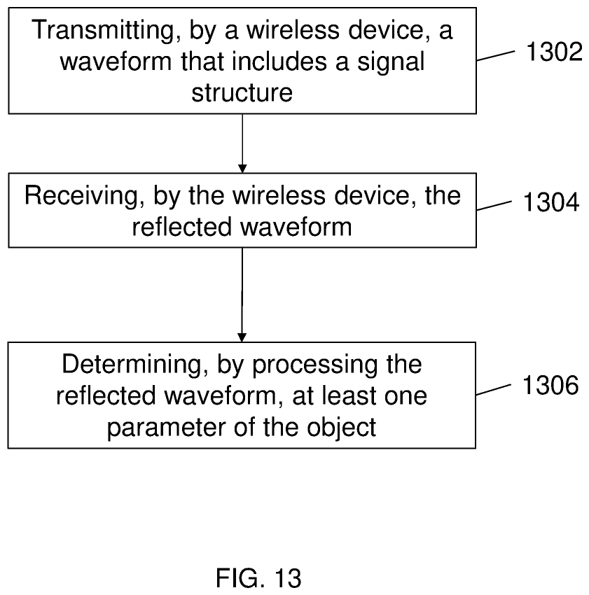

FIG. 13 shows an exemplary flowchart for processing one or more sensing signals in a reflected waveform. Operation 1302 includes transmitting, by a wireless device, a waveform that includes a signal structure, where the signal structure includes a plurality of data signals, where the signal structure includes a plurality of sensing signals configured to reflect from an object in an area where the wireless device is operating resulting in a reflected waveform that comprises at least some of the plurality of sensing signals to be received by the wireless device, and where locations of the plurality of sensing signals in the signal structure form an irregular pattern. Operation 1304 includes receiving, by the wireless device, the reflected waveform. Operation 1306 includes determining, by processing the reflected waveform, at least one parameter of the object.

In some embodiments, the one or more parameters of the object include a distance between the object and the wireless device, a speed of the object, a motion period of the object, or an image of the object. In some embodiments, the signal structure comprises a plurality of time slots, and the irregular pattern is formed by at least one sensing signal that is randomly located in at least one symbol within each time slot from the plurality of time slots. In some embodiments, the signal structure comprises a plurality of time slots, and the irregular pattern is formed by at least one sensing signal that is randomly located within each time slot from the plurality of time slots. In some embodiments, the signal structure comprise a plurality of sub-frames, the irregular pattern is formed by at least one spreading code being randomly selected for at least one sensing signal within each sub-frame of the plurality of sub-frames, each sub-frame includes one or more spreading codes corresponding to one or more data signals, and the at least one spreading code for the at least one sensing signal is different than the one or more spreading codes for the one or more data signals.

In some embodiments, the at least one spreading code includes an orthogonal spreading code in time domain or frequency domain. In some embodiments, the at least one spreading code includes a non-orthogonal spreading code in time domain or frequency domain. In some embodiments, the signal structure comprises a plurality of symbols and a plurality of resource blocks, a set of sensing signals are periodically repeated within the plurality of symbols within each sub-carrier in a subset of sub-carriers from a plurality of sub-carriers, and the irregular pattern is formed by the set of sensing signals that are located in each sub-carrier in the subset of sub-carriers from the plurality of sub-carriers. In some embodiments, the signal structure comprises a plurality of time slots and a plurality of resource blocks, the irregular pattern is formed by one or more sensing signals that are located in each resource block from the plurality of resource blocks, and the irregular pattern is formed by at least one sensing signal that is located in each time slot from the plurality of time slots.

In some embodiments, the signal structure comprises a plurality of symbols and a plurality of resource blocks, a set of sensing signals are periodically repeated within the plurality of symbols within each sub-carrier in a subset of sub-carriers from a plurality of sub-carriers, the irregular pattern is formed by the set of sensing signals that are located in each sub-carrier in the subset of sub-carriers from the plurality of sub-carriers, and a number of sub-carriers in between one sub-carrier that includes the set of sensing signals and another sub-carrier that includes the set of sensing signal increases as a sub-carrier index of the plurality of sub-carriers increases. In some embodiments, the plurality of sensing signals include a frequency modulation continuous wave (FMCW) signal, a pulse signal, or a low-correlation sequence. In some embodiments, the low-correlation sequence includes an m-sequence, a pseudo-noise sequence, a gold sequence, or a Zadoff-Chu sequence. In some embodiments, the plurality of sensing signals are included in a first set of multiple time resources and/or a first set of one or more frequency resources. In some embodiments, the plurality of data signals are included in a second set of one or more time resources and/or a second set of one or more frequency resources. In some embodiments, the wireless device includes a network device or a communication device.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

What is claimed is:

1. A wireless communication method, comprising:
transmitting, by a wireless device, a waveform that includes a signal structure,
wherein the signal structure includes a plurality of data signals,
wherein the signal structure includes a plurality of sensing signals configured to reflect from an object in an area where the wireless device is operating resulting in a reflected waveform that comprises at least some of the plurality of sensing signals to be received by the wireless device, and
wherein locations of the plurality of sensing signals in the signal structure form an irregular pattern;
receiving, by the wireless device, the reflected waveform; and
determining, by processing the reflected waveform, at least one parameter of the object.

2. The method of claim 1, wherein the one or more parameters of the object include a distance between the object and the wireless device, a speed of the object, a motion period of the object, or an image of the object.

3. The method of claim 1,
wherein the signal structure comprises a plurality of time slots, and
wherein the irregular pattern is formed by at least one sensing signal that is randomly located in at least one symbol within each time slot from the plurality of time slots.

4. The method of claim 1,
wherein the signal structure comprises a plurality of time slots, and
wherein the irregular pattern is formed by at least one sensing signal that is randomly located within each time slot from the plurality of time slots.

5. The method of claim 1,
wherein the signal structure comprise a plurality of sub-frames,
wherein the irregular pattern is formed by at least one spreading code being randomly selected for at least one sensing signal within each sub-frame of the plurality of sub-frames,
wherein each sub-frame includes one or more spreading codes corresponding to one or more data signals, and
wherein the at least one spreading code for the at least one sensing signal is different than the one or more spreading codes for the one or more data signals.

6. The method of claim 5, wherein the at least one spreading code includes an orthogonal spreading code in time domain or frequency domain.

7. The method of claim 5, wherein the at least one spreading code includes a non-orthogonal spreading code in time domain or frequency domain.

8. The method of claim 1,
wherein the signal structure comprises a plurality of symbols and a plurality of resource blocks,
wherein a set of sensing signals are periodically repeated within the plurality of symbols within each sub-carrier in a subset of sub-carriers from a plurality of sub-carriers, and
wherein the irregular pattern is formed by the set of sensing signals that are located in each sub-carrier in the subset of sub-carriers from the plurality of sub-carriers.

9. The method of claim 1,
wherein the signal structure comprises a plurality of time slots and a plurality of resource blocks,
wherein the irregular pattern is formed by one or more sensing signals that are located in each resource block from the plurality of resource blocks, and
wherein the irregular pattern is formed by at least one sensing signal that is located in each time slot from the plurality of time slots.

10. The method of claim 1,
wherein the signal structure comprises a plurality of symbols and a plurality of resource blocks,
wherein a set of sensing signals are periodically repeated within the plurality of symbols within each sub-carrier in a subset of sub-carriers from a plurality of sub-carriers,
wherein the irregular pattern is formed by the set of sensing signals that are located in each sub-carrier in the subset of sub-carriers from the plurality of sub-carriers, and
wherein a number of sub-carriers in between one sub-carrier that includes the set of sensing signals and another sub-carrier that includes the set of sensing signal increases as a sub-carrier index of the plurality of sub-carriers increases.

11. The method of claim 1, wherein the plurality of sensing signals include a frequency modulation continuous wave (FMCW) signal, a pulse signal, or a low-correlation sequence.

12. The method of claim 11, wherein the low-correlation sequence includes an m-sequence, a pseudo-noise sequence, a gold sequence, or a Zadoff-Chu sequence.

13. The method of claim 1, wherein the plurality of sensing signals are included in a first set of multiple time resources and/or a first set of one or more frequency resources.

14. An apparatus for wireless communication comprising a processor, configured to implement a method, the processor configured to:
transmit, by a wireless device, a waveform that includes a signal structure,
wherein the signal structure includes a plurality of data signals,
wherein the signal structure includes a plurality of sensing signals configured to reflect from an object in an area where the wireless device is operating resulting in a reflected waveform that comprises at least some of the plurality of sensing signals to be received by the wireless device, and
wherein locations of the plurality of sensing signals in the signal structure form an irregular pattern;
receive, by the wireless device, the reflected waveform; and
determine, by processing the reflected waveform, at least one parameter of the object.

15. The apparatus of claim 14, wherein the one or more parameters of the object include a distance between the object and the wireless device, a speed of the object, a motion period of the object, or an image of the object.

16. The apparatus of claim 14,
wherein the signal structure comprises a plurality of time slots, and
wherein the irregular pattern is formed by at least one sensing signal that is randomly located in at least one symbol within each time slot from the plurality of time slots.

17. The apparatus of claim 14,
wherein the signal structure comprises a plurality of time slots, and
wherein the irregular pattern is formed by at least one sensing signal that is randomly located within each time slot from the plurality of time slots.

18. The apparatus of claim 14,
wherein the signal structure comprise a plurality of sub-frames,
wherein the irregular pattern is formed by at least one spreading code being randomly selected for at least one sensing signal within each sub-frame of the plurality of sub-frames,
wherein each sub-frame includes one or more spreading codes corresponding to one or more data signals, and
wherein the at least one spreading code for the at least one sensing signal is different than the one or more spreading codes for the one or more data signals.

19. The apparatus of claim 18, wherein the at least one spreading code includes an orthogonal spreading code in time domain or frequency domain.

20. The apparatus of claim 18, wherein the at least one spreading code includes a non-orthogonal spreading code in time domain or frequency domain.
